(19) United States
(12) Patent Application Publication
(10) Pub. No.: US 2026/0320972 A1
(43) Pub. Date: Oct. 15, 2026

(54) METHOD AND SYSTEM FOR IDENTIFYING INCREMENTAL VEHICLE DAMAGES

(71) Applicant: LTI Mindtree Ltd., Mumbai (IN)

(72) Inventors: Prantosh Das, Mumbai (IN); Tamilselvan E, Mumbai (IN); Prafulla Kumar Sahu, Mumbai (IN); Akshay Rakesh Toshniwal, Mumbai (IN); Ganesan T, Mumbai (IN); Avula Benzamin, Mumbai (IN); Pavithra P, Mumbai (IN); Gnanasudha K, Mumbai (IN); Ankit Pandita, Mumbai (IN); Pennada Kavya Rasi, Mumbai (IN); Magimai Dass, Mumbai (IN)

(21) Appl. No.: 19/642,689

(22) Filed: Apr. 9, 2026

(30) Foreign Application Priority Data
Apr. 9, 2025 (IN) 202521034698

(51) Int. Cl. G06V 10/764; G06T 7/00; G06V 10/26; G06V 10/62; G06V 10/74; G06V 10/82

(52) U.S. Cl. CPC G06V 10/764; G06T 7/0002; G06V 10/26; G06V 10/62; G06V 10/761; G06V 10/82; G06T 2207/10016; G06T 2207/20084; G06V 2201/08

(57) ABSTRACT

A system for identifying incremental vehicle damages is disclosed. The system receives a multi-angle video footage of a vehicle and identifies a plurality of damage instances using an object detection neural network. For each damage instance a vehicle part region associated with the damage instance is determined using a segmentation neural network and a damage-specific feature vector is generated using a vision transformer neural network. A local reidentification is performed by tracking the plurality of damage instances based on feature vector similarity and assigning unique identifiers to distinct damage instances. A global incremental damage detection is performed by retrieving previously stored feature vectors. Similarity scores between the damage-specific feature vectors and the previously stored feature vectors is calculated using a cosine similarity metric. Damage instances having similar scores below a predetermined threshold are categorized as incremental damages and are stored in a vector database.

### FIELD

Various embodiments of the present disclosure generally relate to identifying vehicle damages. More particularly, the present disclosure relates to a method and system for identifying incremental vehicle damages in real-time using advanced sensor technologies integrated with computer vision and vision transformer based models.

### BACKGROUND

The car rental industry has experienced significant growth over the past decade, driven by increasing urbanization, the rise of shared mobility, and the convenience offered by on-demand vehicle access. However, this growth presents challenges in effectively managing large fleets while maintaining high standards of customer satisfaction and vehicle safety. One of the most pressing concerns for car rental companies is the timely and accurate detection of vehicle damage incurred during rental periods.

The car rental industry operates on a high-frequency vehicle turnover model, where cars are rented, returned, and re-rented multiple times within short periods. Ensuring that vehicles remain in optimal condition while managing a steady influx of customers is a complex challenge for rental companies. One of the critical aspects of fleet management is the accurate and timely assessment of vehicle condition during check-in and check-out procedures.

Typically, car rental companies document each vehicle's state at the beginning and end of a rental period by generating inspection reports accompanied by multiple images capturing various aspects of the vehicle. These images serve as crucial evidence for determining whether any damage occurred during the rental period and for holding customers accountable when necessary. However, manually analyzing these images to detect damages, classify their severity, and determine appropriate actions such as repair scheduling or insurance claims presents a significant operational burden.

Given the large volume of vehicles processed daily, rental companies must handle an extensive amount of visual and textual data. Relying on manual inspection and review processes can lead to inefficiencies, inconsistencies, and potential human errors. Traditional vehicle inspection methods rely on manual checks conducted by staff at the time of vehicle pickup and return. These inspections are often subjective, time-consuming, and prone to human error, leading to disputes between rental agencies and customers regarding responsibility for damages. Delays in detecting damages can result in higher repair costs, reduced vehicle availability, and financial losses due to undetected or unreported incidents. Additionally, inconsistent or inadequate damage assessments may lead to customer dissatisfaction and disputes, negatively impacting the company's reputation.

Detecting vehicle damages and reidentifying them across different rental stations at scale is a highly complex task. To streamline this process, many car rental companies leverage AI to automate damage detection, reducing manual effort and improving accuracy. The automated damage assessment workflow typically consists of three key components: damage detection, reidentification, and segmentation of the affected car parts.

However, several challenges arise in training robust damage classifiers, primarily due to the diverse nature of damages and the scarcity of large, labeled datasets. Unlike traditional object detection tasks, where identified objects tend to have well-defined and homogeneous shapes, damage classification involves irregular, amorphous patterns that vary in severity, texture, and location. This inherent complexity raises questions about the effectiveness of pretrained models in improving damage classification performance, as their generalization capability in such highly variable scenarios remains uncertain.

Existing solutions have explored a wide range of vehicle damages, including dents, glass shatters, broken lamps, scratches, and smashes. These approaches typically involve extensive experimentation with various methodologies to enhance damage detection accuracy. Some methods focus on training convolutional neural networks (CNNs) from scratch, while others employ unsupervised pretraining using auto-encoders followed by fine-tuning. Additionally, transfer learning techniques leveraging CNNs pretrained on large datasets like ImageNet, as well as ensemble classifiers built upon these pretrained models, have been investigated to improve robustness and generalization.

To address challenges such as data set limitations and model overfitting, certain solutions have attempted to curate datasets comprising damaged and undamaged vehicle images sourced from the web. These approaches often incorporate fine-tuning of pretrained models, such as the VGG network, with L2 regularization to mitigate overfitting and enhance classification performance. Despite these advancements, the effectiveness of these methods remains constrained by dataset diversity, variations in damage patterns, and the need for scalable, real-world deployment strategies.

While the findings suggest that combining transfer learning with ensemble learning enhances damage detection performance, it is important to consider the associated trade-offs. Ensemble learning, despite its effectiveness in improving model accuracy and robustness, can impose substantial computational costs. These increased resource demands may, in turn, escalate the operational and maintenance expenses of an automated claim management pipeline, potentially limiting its scalability and real-world feasibility.

Moreover, some existing solutions propose a four-stage pipeline designed to enhance the accuracy of vehicle damage assessment. This pipeline typically includes an initial filtering model to exclude images that do not contain vehicles, followed by a classifier dedicated to identifying bodywork damage. Additionally, two parallel classifiers are employed to estimate both the severity of the damage and its position on the vehicle (e.g., side, rear, or front).

Among deep learning architectures, Mask R-CNN has emerged as a widely used and highly accurate solution for both damage detection and vehicle panel identification. Certain approaches further refine this process by integrating multiple specialized models within a unified pipeline leveraging Mask R-CNN for vehicle panel segmentation, RetinaNet for detecting and recognizing damage, and Inception-V3 for classifying the type and severity of the damage. These advanced techniques demonstrate promising results in automating damage assessment; however, their deployment often requires careful consideration of computational efficiency and scalability in real-world applications.

The challenge of video-based damage reidentification in the car rental industry has received limited attention from the scientific community. This lack of focus, combined with a scarcity of publicly available datasets and a general lack of domain-specific understanding outside the car rental sector, has led to relatively sparse research in this area.

Furthermore, searching for vehicle damages presents significant challenges due to the presence of cluttered backgrounds, occlusions, and variations in viewing conditions. The same damage may appear in different images with variations in viewpoint, scale, and lighting, making the problem similar to object reidentification tasks. However, existing deep reidentification convolutional neural networks (CNNs) often rely on architectures originally designed for generic object classification. These models assume that objects have well-defined, consistent shapes, which is not suitable for the irregular and diverse nature of vehicle damages.

To address these challenges, some solutions propose using OSNet, a network specifically designed to learn multiscale features at each layer. OSNet incorporates multiple convolutional streams within a residual block, allowing for the fusion of multi-scale features with input-dependent channel-wise weights. This architecture enhances spatial-channel correlations and mitigates overfitting, making it well-suited for the variability of damage patterns.

Additionally, recent literature highlights novel reidentification strategies based on attention mechanisms. Some researchers have introduced a transformer-based object reidentification framework, which incorporates a patch module to rearrange patch embeddings and integrates side information embeddings to reduce feature bias caused by variations in camera viewpoints. Furthermore, a dual cross-attention learning algorithm has been proposed to complement self-attention mechanisms, reducing misleading attentions and improving recognition by discovering complementary features. These transformer-based approaches, particularly when trained on large datasets, offer promising avenues for improving vehicle damage reidentification accuracy in real-world applications.

While existing solutions explore various aspects of vehicle damage detection, reidentification, and classification, none are specifically designed to handle real-time incremental damage detection tailored to the unique demands of car rental operations. Traditional approaches primarily focus on static damage assessment, lacking the capability to track and differentiate new damages from pre-existing ones over successive rental periods. However, in a dynamic car rental environment, it is essential to detect and log damages in real time as they occur, enabling accurate liability attribution and minimizing disputes.

The ability to incrementally update damage records without reprocessing the entire dataset is crucial for operational efficiency. The absence of such a solution in existing frameworks highlights a significant gap that must be addressed to enhance automation, reduce costs, and improve overall fleet management.

### SUMMARY

A system for identifying incremental vehicle damages is disclosed. The system receives a multi-angle video footage of a vehicle having a vehicle identifier and identifies a plurality of damage instances in the multi-angle video footage using an object detection neural network trained to recognize specific damage categories. For each of the plurality of damage instances, the system determines a vehicle part region associated with the damage instance using a segmentation neural network and generates a damage-specific feature vector using a vision transformer neural network. Thereafter, the system performs local reidentification by tracking the plurality of damage instances across multiple frames of the multi-angle video footage based on feature vector similarity, and assigning unique identifiers to distinct damage instances among the plurality of damage instances. The system then performs global incremental damage detection by retrieving, from a vector database, previously stored feature vectors associated with the vehicle identifier and associated with vehicle part regions corresponding to the vehicle part regions determined for the plurality of damage instances. Similarity scores between the damage-specific feature vectors of the plurality of damage instances and the previously stored feature vectors is calculated using a cosine similarity metric. The system categorizes damage instances from the plurality of damage instances having similarity scores below a predetermined threshold, as incremental damages. Finally, the system updates the vector database by storing the damage-specific feature vectors of the incremental damages, wherein each damage-specific feature vector is indexed in the vector database by both the vehicle identifier and its associated vehicle part region.

### BRIEF DESCRIPTION OF THE DRAWINGS

FIG. 1 is a diagram that illustrates an exemplary environment within which various embodiments of the present disclosure may function.

FIG. 2 is a diagram that illustrates a system for identifying incremental vehicle damages, in accordance with an embodiment of the disclosure.

FIG. 3 is an exemplary diagram that illustrates input data computation by the YOLO model of the object detection neural network employed by the object detection module, in accordance with an embodiment of the disclosure.

FIG. 4 is an exemplary diagram that illustrates input data computation by the DINO model of the vision transformer neural network employed by the transformer module, in accordance with an embodiment of the disclosure.

FIG. 5 is a diagram that illustrates a flowchart for a method for identifying incremental vehicle damages, in accordance with an embodiment of the disclosure.

### DETAILED DESCRIPTION

Pursuant to various embodiments, the present disclosure provides a method and system for identifying incremental vehicle damages. The system receives a multi-angle video footage of a vehicle having a vehicle identifier and identifies a plurality of damage instances in the multi-angle video footage using an object detection neural network trained to recognize specific damage categories. For each of the plurality of damage instances, the system determines a vehicle part region associated with the damage instance using a segmentation neural network and generates a damage-specific feature vector using a vision transformer neural network. Thereafter, the system performs local reidentification by tracking the plurality of damage instances across multiple frames of the multi-angle video footage based on feature vector similarity, and assigning unique identifiers to distinct damage instances among the plurality of damage instances. The system then performs global incremental damage detection by retrieving, from a vector database, previously stored feature vectors associated with the vehicle identifier and associated with vehicle part regions corresponding to the vehicle part regions determined for the plurality of damage instances. Similarity scores between the damage-specific feature vectors of the plurality of damage instances and the previously stored feature vectors is calculated using a cosine similarity metric. The system categorizes damage instances from the plurality of damage instances having similarity scores below a predetermined threshold, as incremental damages. Finally, the system updates the vector database by storing the damage-specific feature vectors of the incremental damages, wherein each damage-specific feature vector is indexed in the vector database by both the vehicle identifier and its associated vehicle part region.

In one or more embodiments, a vehicle identifier refers to a unique alphanumeric or digital identifier associated with a specific vehicle, enabling precise tracking and record-keeping across multiple rental instances. The vehicle identifier may include, but is not limited to, a Vehicle Identification Number (VIN), license plate number, RFID tag, QR code, or any other unique identifier assigned by the rental company. The vehicle identifier is used to retrieve historical damage records from the vector database, ensuring that newly detected damages can be accurately compared against previously recorded instances for incremental damage detection.

In one or more embodiments, the multi-angle video footage refers to a set of video recordings capturing a vehicle from multiple perspectives to provide a visual representation of its condition. The footage may be obtained using stationary cameras, handheld or mobile devices, drones, or automated inspection systems positioned at different angles around the vehicle. The multi-angle nature of the footage ensures that damages are captured from various viewpoints, reducing occlusions and enhancing the accuracy of damage detection. Additionally, the footage may include time-stamped frames to facilitate sequential analysis, aiding in tracking damage evolution over time.

In one or more embodiments, a damage instance refers to a specific occurrence of vehicle damage identified within the multi-angle video footage. A damage instance may correspond to scratches, dents, cracks, broken lights, or other types of physical damage detected on the vehicle's surface. Each damage instance is characterized by a damage-specific feature vector, which encodes visual attributes such as shape, size, texture, and location. The system tracks damage instances across multiple frames for local reidentification and compares them against previously stored feature vectors for global incremental damage detection.

In one or more embodiments, the vehicle part region refers to a specific area or component of the vehicle where a damage instance is detected. The vehicle part region may include, but is not limited to, the front bumper, rear bumper, hood, doors, fenders, roof, side mirrors, windows, or wheels. The system determines the vehicle part region using a segmentation neural network, which identifies and delineates the affected area within the multi-angle video footage. Each damage instance is associated with a corresponding vehicle part region to facilitate accurate tracking, reidentification, and incremental damage detection across multiple rental periods.

In one or more embodiments, local reidentification refers to the process of tracking and associating a damage instance across multiple frames within the multi-angle video footage of a single inspection session. This process ensures that the same damage instance, appearing in different frames due to variations in viewpoint, lighting, or occlusion, is consistently recognized and assigned a unique identifier. Local reidentification leverages feature vector similarity to match damage instances across frames, reducing redundancy and improving detection accuracy.

In one or more embodiments, the cosine similarity metric refers to a mathematical measure used to determine the degree of similarity between two damage-specific feature vectors in a high-dimensional space. The cosine similarity metric calculates the cosine of the angle between two vectors, yielding a similarity score that ranges from −1 to 1, where 1 indicates identical vectors, 0 indicates no correlation, and −1 indicates completely dissimilar vectors. The system leverages this metric to compare newly detected damage instances with previously stored feature vectors in the vector database, enabling accurate global incremental damage detection by distinguishing new or worsened damages from pre-existing ones.

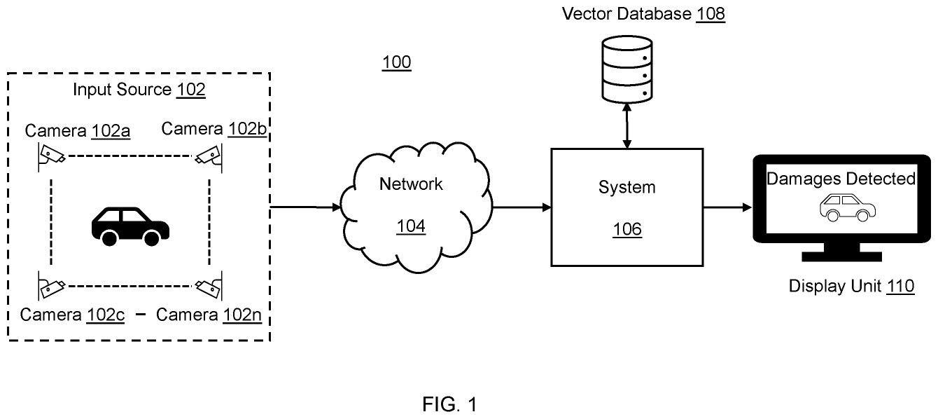

FIG. 1 is a diagram that illustrates an exemplary environment 100 within which various embodiments of the present disclosure may function. Referring to FIG. 1, the environment 100 comprises an input source 102, a network 104, a system 106, a vector database 108, and a display unit 110.

The input source 102 may comprise a plurality of video-capturing cameras, including but not limited to camera 102a, camera 102b, camera 102c . . . camera 102n, strategically positioned to record a vehicle from multiple angles. The cameras may function as Internet of Things (IoT) sensors, enabling seamless connectivity and data transmission to a centralized processing system. By leveraging IoT integration, the plurality of video-capturing cameras can operate in a synchronized manner, capturing multi-angle video footage that provides a visual representation of the vehicle's condition. The vehicle being recorded is associated with a unique vehicle identifier, which serves as a reference for tracking and correlating damage assessments across different inspection events.

In some non-limiting embodiments, the plurality of video-capturing cameras may include any type of cameras without being restricted to a specific category, resolution, or technology. The video-capturing cameras may encompass RGB cameras, infrared (IR) cameras, depth-sensing cameras, stereo cameras, fisheye cameras, LiDAR-equipped cameras, or any other imaging devices capable of capturing visual data of the vehicle from multiple perspectives. The video-capturing cameras may be fixed, mobile, or drone-mounted, and can operate in various lighting and environmental conditions to ensure reliable damage detection. Additionally, the video-capturing cameras may support real-time streaming, high-frame-rate recording, or high-resolution imaging, depending on the implementation needs.

In an exemplary embodiment, multiple angles may include but are not limited to front, rear, left side, right side, top view, and diagonal perspectives of the vehicle. These angles ensure complete coverage of the vehicle's exterior, enabling accurate detection and analysis of damages that may not be visible from a single viewpoint. The plurality of video-capturing cameras may be strategically positioned to minimize blind spots and optimize the visibility of potential damages, such as dents, scratches, cracks, or deformations.

In some non-limiting embodiments, the vehicle can be any type of vehicle, including but not limited to passenger cars, trucks, vans, buses, motorcycles, trailers, and commercial fleet vehicles. The system is designed to accommodate a diverse range of vehicle types, regardless of size, shape, or structural configuration. Additionally, the vehicle may be privately owned, leased, or part of a rental fleet, rideshare service, logistics operation, or autonomous vehicle system.

The network 104 facilitates communication between the various components of the environment 100, including the input source 102, and the system 106. It enables the transfer of data, instructions, and results between the different modules and the system 106, allowing for seamless identification of incremental vehicle damages. The network 104 may comprise various communication protocols, such as local area networks (LAN), wide area networks (WAN), or the internet.

The system 106 is an end-to-end incremental vehicle damage detection system that seamlessly integrates advanced sensor technologies, computer vision, and machine learning algorithms to continuously monitor vehicles for any signs of damage. By systematically comparing the vehicle's condition at check-in and checkout, the system 106 enables incremental damage detection, ensuring the accurate identification of newly incurred damages.

The system 106 is configured to receive and process video footage from multiple vehicle stations, enabling the simultaneous creation of parallel vehicle consumers for high-throughput analysis. It leverages state-of-the-art deep learning models, including You Only Look Once (YOLO) for precise damage localization and a Vision Transformer-based DINO model for robust damage reidentification across multiple frames and inspection events.

Furthermore, the system 106 is built on a scalable, cloud-based architecture, facilitating the efficient processing and storage of large volumes of multi-angle video data. The system 106 architecture facilitates rapid retrieval and analysis, enabling real-time damage assessment with high accuracy and efficiency.

The vector database 108 refers to a structured data repository that stores and manages damage-specific feature vectors associated with previously detected damage instances. Each feature vector is indexed in the vector database 108 using a combination of the vehicle identifier and the corresponding vehicle part region, enabling efficient retrieval and comparison. The vector database 108 facilitates global incremental damage detection by allowing the system 106 to retrieve and compare newly identified damage instances against historical records using cosine similarity metrics.

In an exemplary embodiment, in the vector database 108, each feature vector may be indexed using a combination of:
Vehicle Identifier (e.g., a unique ID for each vehicle)
Vehicle Part Region (e.g., “front bumper,” “left door,” “rear fender”)

In one or more embodiments, the system 106 interacts with the vector database 108 to retrieve previously stored feature vectors that are indexed based on the vehicle identifier and corresponding vehicle part regions. This enables the system 106 to effectively compare newly detected damage instances with historical data for accurate incremental damage detection. Additionally, the system 106 updates the vector database 108 by storing the damage-specific feature vectors of newly identified incremental damages, ensuring that the database remains up to date.

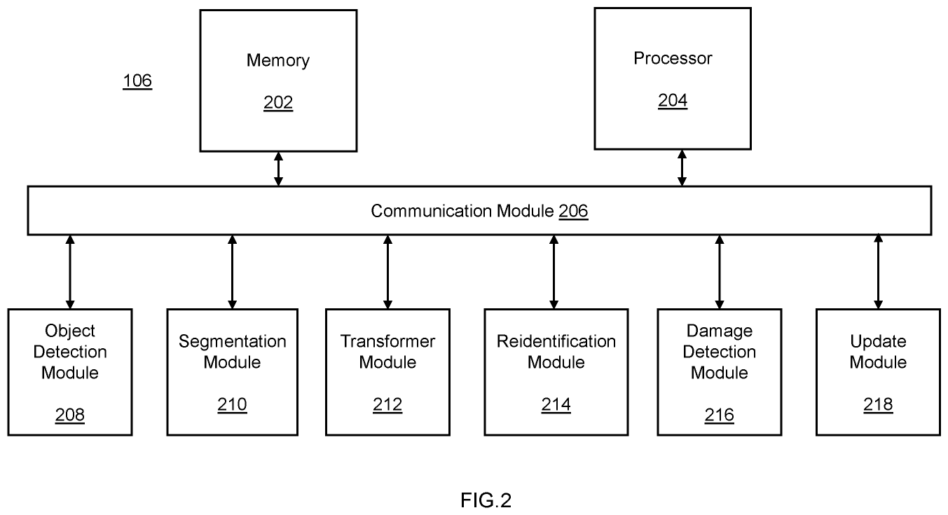

FIG. 2 is a diagram that illustrates the system 106 for identifying incremental vehicle damages, in accordance with an embodiment of the disclosure. Referring to FIG. 2, the system 106 comprises a memory 202, a processor 204, a communication module 206, an object detection module 208, a segmentation module 210, a transformer module 212, a reidentification module 214, a damage detection module 216, and an update module 218.

The memory 202 may comprise suitable logic, code, and/or interfaces that may be configured to store instructions (for example, computer-readable program code) that can implement various aspects of the present disclosure.

The processor 204 may comprise suitable logic, code, and/or interfaces that may be configured to execute the instructions stored in the memory 202 to implement various functionalities of the system 106 in accordance with various aspects of the present disclosure. The communication module 206 is configured to facilitate seamless interaction between the processor 204 and various modules within the system 106.

The system 106 receives multi-angle video footage of a vehicle from the input source 102, which comprises multiple video capturing cameras (camera 102a, camera 102b, camera 102c . . . camera 102n) strategically positioned to cover various perspectives of the vehicle. The cameras continuously capture footage from multiple angles, ensuring comprehensive visual data for damage detection. The captured video footage is then transmitted to the system 106 via the network 104 in real time, facilitating seamless data flow for instantaneous processing and analysis.

In some non-limiting embodiments, the footage captured from multiple angles is transmitted to a distributed broker system by a serverless cloud function that monitors all put events in the storage layer. Upon detecting a new video upload, the cloud function asynchronously forwards the footage to the broker system, ensuring efficient and event-driven data ingestion. The distributed broker system acts as an intermediary message queue, managing video streams and distributing processing tasks among multiple parallel consumers. The consumers deployed across a scalable infrastructure, retrieve the video data and transmit it to a high-performance inference server for further analysis.

The object detection module 208 of the system 106 is configured to analyze multi-angle video footage and accurately detect vehicle damages. It comprises dedicated logic, code, and interfaces that work in conjunction to process video frames in real time and identify multiple instances of vehicle damage. The object detection module 208 leverages an object detection neural network trained to recognize various damage categories, such as dents, scratches, cracks, broken lights, and shattered glass, among others. The object detection neural network is typically trained on a large dataset of vehicle damage images, enabling it to differentiate between damage types and classify them with high precision.

In one or more embodiments, the object detection neural network of the object detection module 208 comprises a YOLO family model, a state-of-the-art deep learning architecture optimized for real-time object detection. The YOLO family model is specifically trained to recognize and classify various types of vehicle damage, ensuring precise and efficient detection in multi-angle video footage. The damage categories identified by the YOLO model include, but are not limited to, scratches, dents, cracks, glass shatters, and lamp breakages.

In one or more embodiments, the YOLO model operates on the principle of single-stage detection, meaning it simultaneously predicts damage locations and classifications in a single forward pass through the neural network. This allows the system 106 to efficiently analyze high-resolution video streams in real time.

In some non-limiting embodiments, the YOLO model used in the object detection module 208 is trained on an extensive dataset comprising labeled images of vehicle damages captured from various angles, lighting conditions, and backgrounds. For instance, the training process may involve:
Data Augmentation: Techniques such as rotation, flipping, contrast adjustment, and noise addition are applied to make the model robust to variations in real-world conditions.
Bounding Box Regression: The model learns to precisely localize damages by predicting bounding boxes around the affected regions.
Multi-Class Classification: The neural network is trained to distinguish between different types of damages, ensuring high classification accuracy.
Anchor Box Optimization: Predefined anchor boxes are fine-tuned to align with the shapes and sizes of different damage types, improving detection performance.

In some non-limiting embodiments, depending on the deployment requirements, different YOLO variants may be utilized by the system 106. For instance:
YOLOv5 or YOLOv8: Offers a balance between speed and accuracy, making it ideal for real-time video processing.
YOLOv7 or Scaled YOLOv4: Enhanced with transformer-based modules for improved small-object detection, beneficial for identifying minor scratches and hairline cracks.

The specific YOLO variants mentioned, such as YOLOv5, YOLOv7, YOLOv8, or Scaled YOLOv4 are provided as exemplary implementations and are not intended to be limiting. The system 106 may employ any other object detection models or their enhanced versions that are capable of accurately detecting and classifying vehicle damages.

The segmentation module 210 may comprise dedicated logic, code, and interfaces that are configured to process multi-angle video footage and accurately determine the vehicle part region corresponding to each identified damage instance. The segmentation module 210 utilizes a segmentation neural network to analyze the spatial characteristics of the damage and localize it within specific regions of the vehicle's exterior. By segmenting the vehicle into predefined parts, the segmentation module 210 enables the system 106 to map damages to precise vehicle components, thereby facilitating more granular tracking and comparison of damages over time.

In an exemplary embodiment, the segmentation neural network works by analyzing multi-angle video footage to precisely identify and delineate different regions of the vehicle's exterior. It processes each frame using convolutional layers that extract spatial features, such as edges, textures, and contours, to distinguish between various vehicle parts. The segmentation neural network then applies pixel-wise classification, assigning each pixel in the image to a predefined vehicle component (e.g., bumper, door, fender). This segmentation allows the system 106 to accurately localize damage instances within specific vehicle regions, ensuring precise tracking and comparison over time.

In one or more embodiments, the segmentation neural network employed by the segmentation module 210 may comprise a UNET model or a variant thereof, trained on vehicle-specific datasets to identify and delineate exterior components such as, but not limited to, the hood, bumper, fenders, doors, side mirrors, roof, windshield, headlights, taillights, and wheels.

In one or more embodiments, the UNET architecture, with its encoder-decoder structure based on skip connections, enables precise pixel-wise segmentation, making it well-suited for identifying complex vehicle parts even under varying lighting conditions, angles, and occlusions.

In some non-limiting embodiments, while UNET is one exemplary model, the segmentation module 210 may also leverage alternative deep learning-based segmentation architectures, including but not limited to Mask R-CNN, DeepLabV3+, PSPNet, SegFormer, and HRNet, depending on requirements such as processing speed, computational efficiency, and accuracy.

The transformer module 212 may comprise dedicated logic, code, and interfaces that are configured to process damage instances detected in the multi-angle video footage and generate corresponding damage-specific feature vectors. The transformer module 212 utilizes a vision transformer neural network to extract deep feature representations from the damage images, so that each damage instance is characterized by a unique and robust numerical signature. The transformer module 212 computes damage-specific feature vectors for every identified damage instance for efficient tracking, comparison, and retrieval of damages across multiple inspection events.

In one or more embodiments, the vision transformer neural network employed by the transformer module 212 comprises a self-supervised DINO (Distillation with No Labels) model, which is trained to generate feature vectors without requiring manually labeled damage data. The DINO model leverages self-supervised learning techniques to understand and differentiate damage patterns while being highly robust to variations in lighting, camera angles, occlusions, and environmental conditions. By learning semantic and structural representations of vehicle damage instances, the DINO-based model enables effective reidentification of damages across multiple frames and even different inspection events.

In some non-limiting embodiments, the vision transformer neural network may be configured to fine-tune its parameters dynamically based on newly observed damage types and updated vehicle inspection data, thereby improving its damage detection and feature extraction performance over time.

In one or more embodiments, the damage-specific feature vectors generated by the transformer module 212 comprise high-dimensional embeddings that encode fine-grained visual characteristics of the damage instances. The feature vectors are designed to be invariant to perspective distortions, lighting fluctuations, and environmental noise, ensuring that the system 106 can accurately compare and distinguish between pre-existing damages and newly incurred damages. By leveraging transformer-based attention mechanisms, the system 106 achieves a high level of contextual understanding, allowing it to focus on relevant damage regions while filtering out irrelevant background noise.

Furthermore, the transformer module 212 provides scalability and adaptability by dynamically updating its feature extraction parameters based on newly captured vehicle damage data, which enables the system 106 to continuously improve its damage recognition capabilities, adapting to new damage types, evolving vehicle designs, and diverse environmental conditions.

The system 106 employs the reidentification module 214, configured for tracking and identifying damage instances across multiple frames of the multi-angle video footage. The reidentification module 214 comprises dedicated logic, code, and/or interfaces configured to execute a local reidentification process, which ensures that the same damage instance observed in different frames is accurately linked while differentiating it from other damages. By leveraging advanced tracking mechanisms, the reidentification module 214 analyzes feature vector similarities among damage instances detected in successive frames, enabling precise damage association and continuity tracking.

In one or more embodiments, the local reidentification process involves computing feature vector similarities to determine whether a detected damage instance in a given frame corresponds to a previously observed damage or represents a new instance. The system 106 then assigns a unique identifier to each distinct damage instance, ensuring that damage tracking remains consistent throughout the video footage.

In one or more embodiments, the reidentification module 214 employs a Deep SORT (Simple Online and Realtime Tracking) algorithm to achieve robust and real-time damage tracking. The Deep SORT algorithm extends the classic SORT (Simple Online Realtime Tracker) framework by integrating a deep appearance descriptor, which enables the system 106 to track damage instances even in cases where occlusions, lighting changes, or motion blur may occur. Deep SORT facilitates continuous reidentification of damage instances across frames by utilizing a combination of Kalman filtering for motion prediction and deep learning-based feature embeddings for appearance matching.

In some non-limiting embodiments, the Deep SORT-based tracking approach is further enhanced by incorporating IoU-based (Intersection over Union) association metrics, which improve damage localization accuracy by assessing the spatial overlap between detected damages across frames.

The damage detection module 216 is configured to perform global incremental damage detection, so that newly incurred damages are accurately identified by comparing current damage instances against historical records. The damage detection module 216 comprises dedicated logic, code, and/or interfaces that enable systematic comparison between previously stored feature vectors and newly extracted damage-specific feature vectors.

In one or more embodiments, the global incremental damage detection process follows a structured sequence of operations. First, the damage detection module 216 retrieves previously stored feature vectors from a vector database 108. The stored feature vectors correspond to vehicle part regions previously associated with the vehicle identifier, ensuring that only relevant data is considered during the damage comparison process. Next, the system 106 calculates similarity scores by comparing the damage-specific feature vectors extracted from the plurality of damage instances against the retrieved historical feature vectors. This comparison is performed using a cosine similarity metric, which measures the angular similarity between the newly detected damage representations and existing stored representations. Finally, the damage detection module 216 categorizes the damage instances that exhibit similarity scores below a predetermined threshold as incremental damages, indicating that they do not sufficiently match any previously recorded damage and are likely to be new.

In one or more embodiments, the similarity score computation is performed using a cosine similarity function, which determines the degree of resemblance between damage-specific feature vectors and previously stored feature vectors. The cosine similarity metric is particularly well-suited for high-dimensional feature spaces, ensuring that subtle variations in damage texture, shape, and structural characteristics are captured effectively. By computing cosine similarity values, the system 106 achieves a robust and scalable comparison process, minimizing the likelihood of misclassification while maintaining high accuracy in detecting newly incurred damages.

Further, the damage detection module 216 optimizes the retrieval of previously stored feature vectors by limiting the search space to only those feature vectors associated with vehicle part regions corresponding to the plurality of damage instances. By constraining the retrieval process, the system 106 may minimize false positive matches, enhancing the efficiency and precision of incremental damage detection.

The update module 218 is responsible for maintaining and dynamically updating the vector database 108 by incorporating newly identified damage-specific feature vectors corresponding to incremental damages. The update module 218 comprises dedicated logic, code, and/or interfaces that may be configured to index and store damage feature vectors in a structured and retrievable manner. By continuously updating the vector database 108 with new damage records, the system 106 ensures that an accurate historical record of vehicle damages is maintained, enabling progressive damage assessment over time.

In one or more embodiments, upon identifying incremental damages, the update module 218 stores the corresponding damage-specific feature vectors in the vector database 108 while indexing them based on two primary attributes:
The vehicle identifier—Uniquely linking the damage instance to a specific vehicle.
The associated vehicle part region—Confirm that future retrieval operations are constrained to relevant vehicle parts, optimizing performance.

The structured indexing allows the system 106 to retrieve relevant historical data efficiently when performing future damage assessments, minimizing unnecessary computations and reducing false positives during similarity comparisons.

In one or more embodiments, the update module 218 utilizes an indexing structure optimized for high-dimensional feature vector retrieval, facilitating fast and accurate damage comparisons. The indexing structure may incorporate spatial partitioning techniques, such as KD-Trees, HNSW (Hierarchical Navigable Small World) graphs, or FAISS-based (Facebook AI Similarity Search) indexing, to enable efficient nearest-neighbor searches within the stored feature space.

In one or more embodiments, the system 106 is further configured to automatically generate a damage report that presents a structured summary of incremental damages detected during the inspection process to a user on the display unit 110.

In an exemplary embodiment, as illustrated in Table 1 below, the report includes a detailed mapping of each identified damage instance, linking it to its corresponding vehicle part region, and offering a clear before-and-after comparison based on previously stored inspection data. The report uniquely associates the inspection results with a specific vehicle identifier, ensuring traceability and accountability. Each incremental damage is categorized based on its damage type, such as scratches, dents, cracks, glass shatters, or lamp breakages, and is further linked to the corresponding vehicle part region where it was detected, facilitating precise localization.

TABLE 1

| | | Vehicle | | | | Incremental |
|---|---|---|---|---|---|---|
| Vehicle | Inspection | Part | Damage | Previous | Current | Damage |
| Identifier | Stage | Region | Type | Count | Count | Count |
| ABC-1234 | Before Rental | Front Bumper | Scratches | 2 | 2 | 0 |
| ABC-1234 | After Rental | Front Bumper | Scratches | 2 | 4 | 2 |
| ABC-1234 | Before Rental | Left Door | Dents | 1 | 1 | 0 |

In some non-limiting embodiments, to improve clarity and verification, the report may also include timestamped evidence in the form of annotated images or video snapshots highlighting the detected damages, allowing stakeholders to visually confirm the extent and nature of the damages. Additionally, the report incorporates similarity scores, which are computed based on the cosine similarity metric, to quantify how distinct each new damage instance is compared to previously stored feature vectors, thereby ensuring accurate classification of incremental damages. The system 106 may also include a severity assessment module that evaluates the magnitude of each damage instance based on predefined classification thresholds, providing insights into whether the damage is minor, moderate, or severe.

In some non-limiting embodiments, the report is automatically formatted and exported in structured file formats, such as PDF, JSON, or XML, enabling seamless integration with insurance claim systems, fleet management platforms, or rental service applications.

In some non-limiting embodiments, the system 106 may incorporate visual analytics capabilities to enhance the damage report, allowing users to interactively review detected damages through dashboard interfaces that support filtering, comparative analysis, and historical tracking of damages across multiple inspection events.

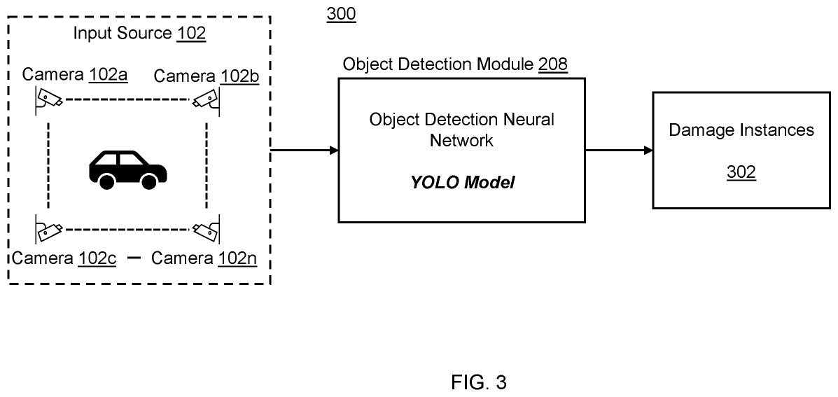

FIG. 3 is a diagram 300 that illustrates input data computation by the YOLO model of the object detection neural network employed by the object detection module 208, in accordance with an exemplary embodiment of the disclosure. Referring to FIG. 3, the diagram 300 comprises the input source 102, the object detection module 208, and damage instances 302.

In one or more embodiments, the YOLO model within the object detection neural network processes input video frames captured by the input source 102, applying a grid-based approach to efficiently detect and classify damage instances in real time. Specifically, the YOLO model partitions each video frame into a predefined grid and predicts bounding boxes, objectness scores, and class probabilities for each grid cell, enabling the identification of the damage instances 302 such as, but not limited to, scratches, dents, cracks, glass shatters, and lamp breakages.

Referring to FIG. 3, the YOLO model employed by the object detection neural network operates on specific mathematical formulations as given below:

$$L = {α}_{l o c} {\sum }_{m = 0}^{{G}^{2}} {\sum }_{n = 0}^{B} {δ}_{m n}^{o b j} [ {( {\tilde{x}}_{m} - {x}_{m} )}^{2} + {( {\tilde{y}}_{m} - {y}_{m} )}^{2} ] + {α}_{l o c} {\sum }_{m = 0}^{{G}^{2}} {\sum }_{n = 0}^{B} {δ}_{m n}^{o b j} [ {( \sqrt{{\tilde{w}}_{m}} - \sqrt{{w}_{m}} )}^{2} + {( \sqrt{{\tilde{h}}_{m}} - \sqrt{{h}_{m}} )}^{2} ] + {\sum }_{m = 0}^{{G}^{2}} {\sum }_{n = 0}^{B} {δ}_{m n}^{o b j} [ {( {S}_{m} - {\tilde{S}}_{m} )}^{2} ] + {β}_{n o o b j} {\sum }_{m = 0}^{{G}^{2}} {\sum }_{n = 0}^{B} {δ}_{m n}^{n o o b j} [ {( {S}_{m} - {\tilde{S}}_{m} )}^{2} ] + {\sum }_{m = 0}^{{G}^{2}} {δ}_{m}^{o b j} {\sum }_{c ε c l a s s e s} [ {( P ( {c}_{m} ) - \tilde{P} ( {c}_{m} ) )}^{2} ]$$

where:
G² is the total number of grid cells,
B represents the number of bounding boxes assigned per grid cell,

$${δ}_{m n}^{n o o b j}$$

is an indicator function that is 1 if an object is present in the n^{th} bounding box of the m^{th} grid cell, and 0 otherwise,
α_{loc} and β_{noobj} are scaling coefficients for localization and confidence loss terms, respectively.

The formulations govern key computations, including bounding box regression, confidence score estimation, and class probability assignments, ensuring precise localization and classification of damage instances.

In one or more embodiments, by leveraging the aforementioned mathematical formulations, the YOLO model facilitates real-time, high-accuracy detection of vehicle damages, allowing the object detection module 208 to efficiently process multi-angle video footage.

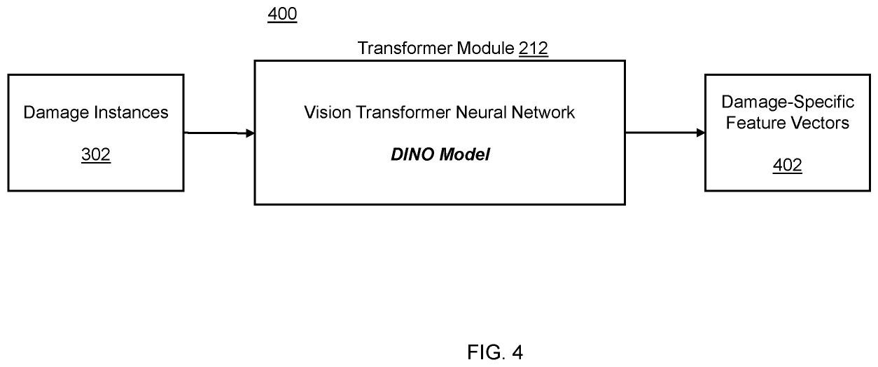

FIG. 4 is an exemplary diagram 400 that illustrates input data computation by the DINO model of the vision transformer neural network employed by the transformer module 212, in accordance with an exemplary embodiment of the disclosure. Referring to FIG. 4, the exemplary diagram 400 comprises the damage instances 302, the transformer module 212, and damage-specific feature vectors 402.

With reference to FIG. 4, the DINO model within the vision transformer neural network processes the detected damage instances 302 by encoding high-dimensional feature representations that are invariant to changes in lighting, viewing angles, and environmental conditions. The DINO model employs self-supervised learning techniques to extract rich semantic features from input data without requiring explicit labels. This enables the transformer module 212 to generate the damage-specific feature vectors 402 that capture the distinguishing visual characteristics of each damage instance.

Referring to FIG. 4, the DINO model employed by the vision transformer neural network operates on specific mathematical formulations as given below:

### 1. Feature Representation Extraction

z=f_{θ}(x)

where:
x is the input image or data,
f_{θ}(x) is the feature extraction network (e.g., ResNet, ViT),
z is the extracted feature representation.

### 2. Projected Feature Representation

p=g_{φ}(z)

where:
g_{φ}(z) is a projection head that maps features into another space.

### 3. Contrastive Learning Loss (if Applicable)

$${ℒ}_{contrastive} = - log \frac{exp ( sim ( {z}_{i} , {z}_{j} ) / τ )}{{\sum }_{k} exp ( s i m ( {z}_{i} , {z}_{k} ) / τ )}$$

where:
sim(zᵢ,zⱼ) is the similarity measure (e.g., cosine similarity),
τ is the temperature parameter.

### 4. Student-Teacher Model (if Applicable)

zₛ=f_{θ}_{ₛ}(x), zₜ=f_{θ}_{ₜ}(x)

where:
zₛ and zₜ are features from the student and teacher models.

In one or more embodiments, by leveraging the aforementioned mathematical formulations, the DINO model facilitates that the damage-specific feature vectors 402 maintain high consistency across varying conditions, thereby enabling reliable damage reidentification across multiple frames and inspection events. The transformer module 212 utilizes these feature vectors for downstream processing, including similarity-based matching and incremental damage detection.

### Exemplary Embodiment

Consider an exemplary embodiment, where a customer arrives at a fleet company to rent a vehicle. Before handing over the car, the company initiates an inspection using the system 106, which utilizes a multi-angle camera setup to capture video footage of the vehicle. As the footage is recorded, a serverless cloud function continuously monitors all put events and asynchronously transmits the videos to a distributed broker system. A set of parallel consumers retrieves these videos and forwards them to a highly scalable inference server, where the system 106 processes the captured video footage to detect damages using its components.

By utilizing a distributed architecture, the broker layer of the distributed broker system manages high-throughput data streams to ensure fault tolerance and load balancing. The architecture enables the dynamic instantiation of multiple parallel consumers that operate concurrently, optimizing resource utilization and minimizing processing latency.

The object detection module 208 detects visible damages such as scratches and dents. For instance, it identifies 3 scratches and 4 dents on different parts of the car.

The segmentation module 210 maps the detected damages to specific vehicle parts. For instance:
Scratch 1: Front bumper
Scratch 2: Left door
Scratch 3: Rear fender
Dent 1 & 2: Left door
Dent 3 & 4: Rear fender

The transformer module 212 extracts damage-specific feature vectors for each detected damage instance. The damage-specific feature vectors encode information about the damage type, size, depth, and position.

The reidentification module 214 assigns unique identifiers to each detected damage instance, ensuring that each damage is tracked across multiple frames.

The update module 218 stores all identified damages and their corresponding feature vectors in the vector database 108, indexed by both vehicle identifier and vehicle part region.

At this stage, the fleet company now has a digital record of the car's condition before it was rented. The system 106 logs:
3 scratches (front bumper, left door, rear fender)
4 dents (left door, rear fender)

The car is then handed over to the customer.

After a week, for instance, the customer returns the vehicle. The fleet company performs another inspection using the same multi-angle camera setup.

The object detection module 208 identifies damages again, detecting 6 scratches and 5 dents.

The segmentation module 210 maps the new set of detected damages to vehicle parts:
Scratch 1: Front bumper
Scratch 2: Left door
Scratch 3: Rear fender
Scratch 4: Right door (new)
Scratch 5: Rear bumper (new)
Scratch 6: Roof (new)
Dent 1 & 2: Left door
Dent 3 & 4: Rear fender
Dent 5: Front fender (new)

At this point, the system 106 has detected a total of 6 scratches and 5 dents, but it must determine which of these are new damages.

The damage detection module 216 performs incremental damage analysis by comparing the newly detected damage-specific feature vectors with the previously stored vectors from the initial inspection.
Similarity Score Calculation: The system 106 uses a cosine similarity metric to compare each new damage vector with the existing stored damage vectors.
Threshold-Based Classification:
   If a detected damage closely matches a previously stored damage (i.e., high similarity score), it is classified as a pre-existing damage.
   If a detected damage does not match any stored damage (i.e., low similarity score), it is classified as a new incremental damage.

### Results of the Comparison:

Pre-existing damages: 3 scratches and 4 dents match the previous records.
New incremental damages:
   3 new scratches (right door, rear bumper, roof)
   1 new dent (front fender)

The system 106 identifies these incremental damages as new because their feature vectors do not match any previously recorded damages.

The update module 218 adds the new damage-specific feature vectors (corresponding to the new scratches and dent) to the vector database 108, ensuring future inspections account for them.

The system 106 generates a damage report, highlighting:
Pre-existing damages (for reference).
New damages detected (incremental damages).
Visual evidence with bounding boxes and segmentation overlays.

This report (as illustrated in the table below) is automatically sent to the fleet company's damage assessment team for further action.

TABLE 2

| Damage | Pre-rental | Post-rental | |
|---|---|---|---|
| Type | count | count | Incremental Damages |
| Scratches | 3 | 6 | 3 new scratches |
| | | | (right door, rear bumper, roof) |
| Dents | 4 | 5 | 1 new dent (front fender) |

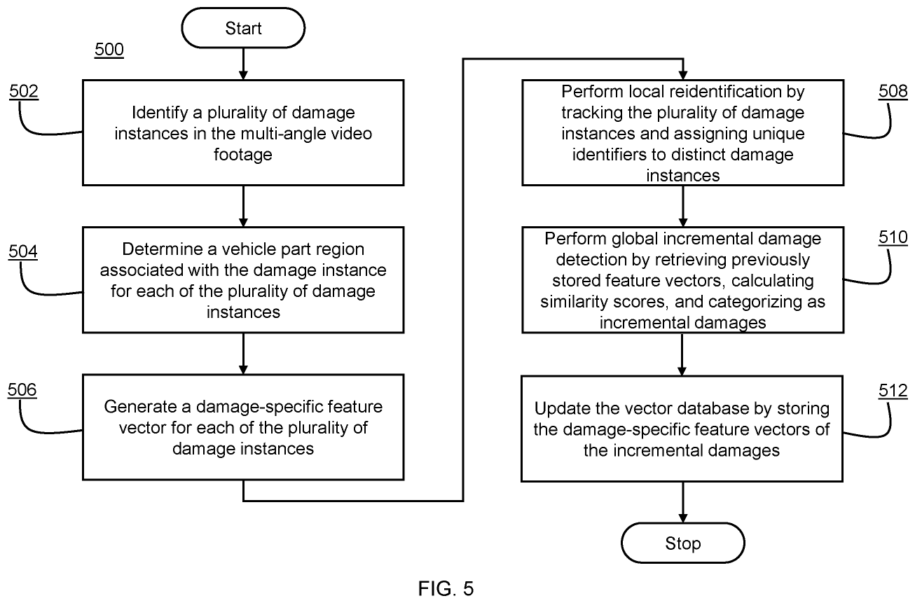

FIG. 5 is a diagram that illustrates a flowchart for a method 500 for identifying incremental vehicle damages, in accordance with an embodiment of the disclosure.

The system 106 initially receives a multi-angle video footage of a vehicle having a vehicle identifier, from the input source 102 in real-time.

In some non-limiting embodiments, the footage captured from multiple angles is transmitted to a distributed broker system by a serverless cloud function that monitors all put events in the storage layer. Upon detecting a new video upload, the cloud function asynchronously forwards the footage to the broker system, ensuring efficient and event-driven data ingestion. The distributed broker system acts as an intermediary message queue, managing video streams and distributing processing tasks among multiple parallel consumers.

At 502, the object detection module 208 identifies a plurality of damage instances in the multi-angle video footage using an object detection neural network trained to recognize specific damage categories. The object detection neural network is typically trained on a large dataset of vehicle damage images, enabling it to differentiate between damage types and classify them with high precision.

In one or more embodiments, the object detection neural network of the object detection module 208 comprises a You Only Look Once (YOLO) family model, a state-of-the-art deep learning architecture optimized for real-time object detection. The YOLO model is specifically trained to recognize and classify various types of vehicle damage, ensuring precise and efficient detection in multi-angle video footage. The damage categories identified by the YOLO model include, but are not limited to, scratches, dents, cracks, glass shatters, and lamp breakages.

In one or more embodiments, the YOLO model operates on the principle of single-stage detection, meaning it simultaneously predicts damage locations and classifications in a single forward pass through the neural network. This allows the system 106 to efficiently analyze high-resolution video streams in real time.

In some non-limiting embodiments, the YOLO model used in the object detection module 208 is trained on an extensive dataset comprising labeled images of vehicle damages captured from various angles, lighting conditions, and backgrounds.

At 504, for each of the plurality of damage instances, a vehicle part region associated with the damage instance is determined by the segmentation module 210 using a segmentation neural network.

The segmentation module 210 utilizes a segmentation neural network to analyze the spatial characteristics of the damage and localize it within specific regions of the vehicle's exterior. By segmenting the vehicle into predefined parts, the segmentation module 210 enables the system 106 to map damages to precise vehicle components, thereby facilitating more granular tracking and comparison of damages over time.

In an exemplary embodiment, the segmentation neural network works by analyzing multi-angle video footage to precisely identify and delineate different regions of the vehicle's exterior. It processes each frame using convolutional layers that extract spatial features, such as edges, textures, and contours, to distinguish between various vehicle parts. The segmentation neural network then applies pixel-wise classification, assigning each pixel in the image to a predefined vehicle component (e.g., bumper, door, fender). This segmentation allows the system 106 to accurately localize damage instances within specific vehicle regions, ensuring precise tracking and comparison over time.

In one or more embodiments, the segmentation neural network employed by the segmentation module 210 may comprise a UNET model or a variant thereof, trained on vehicle-specific datasets to identify and delineate exterior components such as, but not limited to, the hood, bumper, fenders, doors, side mirrors, roof, windshield, headlights, taillights, and wheels.

At 506, a damage-specific feature vector for each of the plurality of damage instances is generated by the transformer module 212 using a vision transformer neural network. The transformer module 212 computes damage-specific feature vectors for every identified damage instance for efficient tracking, comparison, and retrieval of damages across multiple inspection events.

In one or more embodiments, the vision transformer neural network employed by the transformer module 212 comprises a self-supervised DINO (Distillation with No Labels) model, which is trained to generate feature vectors without requiring manually labeled damage data. The DINO model leverages self-supervised learning techniques to understand and differentiate damage patterns while being highly robust to variations in lighting, camera angles, occlusions, and environmental conditions. By learning semantic and structural representations of vehicle damage instances, the DINO-based model enables effective reidentification of damages across multiple frames and even different inspection events.

In some non-limiting embodiments, the vision transformer neural network may be configured to fine-tune its parameters dynamically based on newly observed damage types and updated vehicle inspection data, thereby improving its damage detection and feature extraction performance over time.

In one or more embodiments, the damage-specific feature vectors generated by the transformer module 212 comprise high-dimensional embeddings that encode fine-grained visual characteristics of the damage instances. The feature vectors are designed to be invariant to perspective distortions, lighting fluctuations, and environmental noise, ensuring that the system 106 can accurately compare and distinguish between pre-existing damages and newly incurred damages. By leveraging transformer-based attention mechanisms, the system 106 achieves a high level of contextual understanding, allowing it to focus on relevant damage regions while filtering out irrelevant background noise.

Furthermore, the transformer module 212 provides scalability and adaptability by dynamically updating its feature extraction parameters based on newly captured vehicle damage data, which enables the system 106 to continuously improve its damage recognition capabilities, adapting to new damage types, evolving vehicle designs, and diverse environmental conditions.

At 508, the reidentification module 214 performs local reidentification by tracking and identifying damage instances across multiple frames of the multi-angle video footage. The reidentification module 214 executes a local reidentification process, which ensures that the same damage instance observed in different frames is accurately linked while differentiating it from other damages. By leveraging advanced tracking mechanisms, the reidentification module 214 analyzes feature vector similarities among damage instances detected in successive frames, enabling precise damage association and continuity tracking.

In one or more embodiments, the local reidentification process involves computing feature vector similarities to determine whether a detected damage instance in a given frame corresponds to a previously observed damage or represents a new instance. The system 106 then assigns a unique identifier to each distinct damage instance, ensuring that damage tracking remains consistent throughout the video footage.

In one or more embodiments, the reidentification module 214 employs a Deep SORT algorithm to achieve robust and real-time damage tracking. The Deep SORT algorithm extends the classic SORT framework by integrating a deep appearance descriptor, which enables the system 106 to track damage instances even in cases where occlusions, lighting changes, or motion blur may occur. Deep SORT facilitates continuous reidentification of damage instances across frames by utilizing a combination of Kalman filtering for motion prediction and deep learning-based feature embeddings for appearance matching.

In some non-limiting embodiments, the Deep SORT-based tracking approach is further enhanced by incorporating IoU-based (Intersection over Union) association metrics, which improve damage localization accuracy by assessing the spatial overlap between detected damages across frames.

At 510, the damage detection module 216 performs global incremental damage detection by initially retrieving previously stored feature vectors from a vector database 108. The stored feature vectors correspond to vehicle part regions previously associated with the vehicle identifier, ensuring that only relevant data is considered during the damage comparison process. Next, the system 106 calculates similarity scores by comparing the damage-specific feature vectors extracted from the plurality of damage instances against the retrieved historical feature vectors. This comparison is performed using a cosine similarity metric, which measures the angular similarity between the newly detected damage representations and existing stored representations. Finally, the damage detection module 216 categorizes the damage instances that exhibit similarity scores below a predetermined threshold as incremental damages, indicating that they do not sufficiently match any previously recorded damage and are likely to be new.

In one or more embodiments, the similarity score computation is performed using a cosine similarity function, which determines the degree of resemblance between damage-specific feature vectors and previously stored feature vectors. The cosine similarity metric is particularly well-suited for high-dimensional feature spaces, ensuring that subtle variations in damage texture, shape, and structural characteristics are captured effectively. By computing cosine similarity values, the system 106 achieves a robust and scalable comparison process, minimizing the likelihood of misclassification while maintaining high accuracy in detecting newly incurred damages.

Further, the damage detection module 216 optimizes the retrieval of previously stored feature vectors by limiting the search space to only those feature vectors associated with vehicle part regions corresponding to the plurality of damage instances. By constraining the retrieval process, the system 106 may minimize false positive matches, enhancing the efficiency and precision of incremental damage detection.

At 512, the vector database is updated by the update module 218 by storing the damage-specific feature vectors of the incremental damages. Each damage-specific feature vector is indexed in the vector database by both the vehicle identifier and its associated vehicle part region. By continuously updating the vector database 108 with new damage records, the system 106 ensures that an accurate historical record of vehicle damages is maintained, enabling progressive damage assessment over time.

The structured indexing allows the system 106 to retrieve relevant historical data efficiently when performing future damage assessments, minimizing unnecessary computations and reducing false positives during similarity comparisons.

The method and system offer significant technical advantages by integrating advanced sensor technologies, state-of-the-art computer vision techniques, and deep learning-based damage classification models. By leveraging high-resolution imaging and real-time neural network inference, the system accurately detects, localizes, and categorizes a wide spectrum of damages, ranging from superficial scratches to structurally significant dents. The multi-modal approach enhances robustness against variations in lighting, angle, and environmental conditions, ensuring precise and consistent damage assessment. Furthermore, the system's ability to generate damage-specific feature vectors facilitates incremental damage tracking, enabling automated, tamper-proof, and objective evaluations over time.

The system fully automates the damage detection process by leveraging real-time data from high-resolution cameras and advanced sensor inputs, eliminating the inefficiencies associated with manual inspections. By utilizing deep learning-based object detection and segmentation techniques, the system ensures precise identification and classification of damages with minimal human intervention. This automation not only enhances accuracy but also mitigates inconsistencies and subjectivity inherent in manual assessments, significantly reducing the likelihood of human error. Additionally, the system's ability to process multi-angle video footage in real time enables comprehensive damage analysis, leading to faster and more reliable evaluations.

The system employs an optimized and scalable approach that effectively balances detection accuracy and computational efficiency. By leveraging lightweight yet powerful computer vision models, such as YOLO for real-time object detection and Vision Transformer-based feature extraction, the system ensures precise damage identification while minimizing processing overhead. Additionally, the integration of a cloud-based infrastructure enables efficient handling of large-scale multi-angle video data, ensuring seamless parallel processing and rapid inference without excessive computational costs. Through model optimizations, hardware acceleration (e.g., GPU/TPU processing), and intelligent data indexing, the system maintains high-performance execution while remaining cost-effective and scalable for fleet-wide deployment.

The system employs an optimized and scalable approach that effectively balances detection accuracy and computational efficiency. By leveraging lightweight yet powerful computer vision models, such as YOLO for real-time object detection and Vision Transformer-based feature extraction, the system ensures precise damage identification while minimizing processing overhead. Additionally, the integration of a cloud-based infrastructure enables efficient handling of large-scale multi-angle video data, ensuring seamless parallel processing and rapid inference without excessive computational costs.

Furthermore, the system is designed for scalability, incorporating cloud-native services, serverless computing, and a modular microservices architecture. This allows the system to dynamically allocate resources based on workload demand, handle high-throughput data streams, and efficiently process large volumes of damage detection requests across multiple locations. By utilizing distributed processing frameworks and optimized data pipelines, the system ensures fault tolerance, low latency, and seamless expansion, making it suitable for enterprise-scale fleet management operations.

The system employs an incremental damage detection approach, which systematically compares the vehicle's condition at check-in and checkout to accurately identify newly occurring damages. By leveraging a combination of computer vision, deep learning, and feature vector analysis, the system ensures that even subtle variations in damage patterns such as the emergence of new scratches, dents, or cracks—are detected with high precision. Through feature vector-based similarity analysis, the system retrieves previously stored damage-specific feature vectors from a vector database and computes similarity scores between the newly detected damage instances and historical records. Any damage instance exhibiting a similarity score below a predefined threshold is classified as an incremental damage, ensuring that new damages are systematically documented. This automated, data-driven approach minimizes disputes, enhances transparency, and provides an objective damage assessment, which is particularly beneficial for rental and fleet management applications.

Furthermore, the system leverages the YOLO model for precise damage detection, enabling real-time identification of various damage types, such as scratches, dents, cracks, glass shatters, and lamp breakages. The YOLO model efficiently processes multi-angle video footage from cameras, applying a single-shot object detection approach to localize and classify damage instances with high accuracy. This rapid detection mechanism significantly enhances operational efficiency by reducing processing time while maintaining detection precision.

For effective damage reidentification, the system employs a Vision Transformer-based DINO model, which generates high-dimensional feature vectors representing the detected damage instances. The DINO model, being self-supervised, eliminates the need for extensive labeled datasets and ensures robust feature extraction even under varying lighting conditions, angles, and environmental factors. By analyzing and comparing these feature vectors across different timeframes, the system can track damage evolution, identify incremental damages, and distinguish between pre-existing and newly introduced damage instances. This integration of YOLO for detection and DINO for reidentification provides a comprehensive, AI-driven approach to automated damage assessment, enhancing accuracy, scalability, and reliability in real-world applications such as rental fleets, insurance assessments, and vehicle inspections.

The damage reidentification module serves as a fundamental component within the system's pipeline, leveraging advanced feature extraction and similarity analysis techniques to enhance accuracy in detecting incremental damages. The system ensures that damage instances identified by preceding modules are systematically compared against historical records using high-dimensional feature embeddings, enabling precise differentiation between pre-existing and newly incurred defects. A high-performing reidentification model is crucial, as it significantly reduces false positives, thereby minimizing unnecessary manual verification efforts by claims experts. By integrating state-of-the-art deep learning architectures and similarity metrics, the system optimizes reliability in damage assessment, improving operational efficiency and reducing costs associated with erroneous damage claims.

The system leverages a distributed broker queue to achieve a significant technical advantage over conventional solutions. By utilizing a distributed architecture, the broker layer efficiently manages high-throughput data streams, ensuring fault tolerance and load balancing. This architecture enables the dynamic instantiation of multiple parallel consumers that operate concurrently, optimizing resource utilization and minimizing processing latency. As a result, the system significantly enhances throughput, allowing for the seamless handling of large-scale video data in real-time.

Moreover, the distributed broker queue significantly enhances the system's reliability and scalability. In the event of a consumer failure due to unforeseen circumstances, the broker queue implements an acknowledgment-based processing mechanism. If a consumer fails to process a video, it does not send an acknowledgment to the broker, ensuring that the unprocessed video remains in the queue. The broker then automatically reschedules the video for processing by another available consumer, enabling fault tolerance and ensuring uninterrupted workflow execution. This mechanism not only mitigates the risk of data loss but also enhances system resilience by dynamically redistributing workloads based on consumer availability.

Additionally, by decoupling the video processing layer from the video ingestion layer, the present disclosure enables seamless horizontal scaling of the system. This architectural separation allows multiple parallel consumers to be instantiated across distributed machines, effectively distributing the computational workload. As a result, the system can dynamically scale based on demand, optimizing resource allocation and preventing bottlenecks. This approach ensures efficient handling of high-volume video data while maintaining low-latency processing, making the system highly adaptable to varying workloads.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of the ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A system for identifying incremental vehicle damages, comprising:
a processor;
a memory storing instructions that, when executed by the processor, configure the system to:
receive a multi-angle video footage of a vehicle having a vehicle identifier;
identify a plurality of damage instances in the multi-angle video footage using an object detection neural network trained to recognize specific damage categories;
determine, for each of the plurality of damage instances, a vehicle part region associated with the damage instance using a segmentation neural network;
generate, for each of the plurality of damage instances, a damage-specific feature vector using a vision transformer neural network;
perform local reidentification by:
tracking the plurality of damage instances across multiple frames of the multi-angle video footage based on feature vector similarity;
assigning unique identifiers to distinct damage instances among the plurality of damage instances;
perform global incremental damage detection by:
retrieving, from a vector database, previously stored feature vectors associated with the vehicle identifier and associated with vehicle part regions corresponding to the vehicle part regions determined for the plurality of damage instances;
calculating similarity scores between the damage-specific feature vectors of the plurality of damage instances and the previously stored feature vectors using a cosine similarity metric;
categorizing, as incremental damages, damage instances from the plurality of damage instances having similarity scores below a predetermined threshold; and
update the vector database by storing the damage-specific feature vectors of the incremental damages, wherein each damage-specific feature vector is indexed in the vector database by both the vehicle identifier and its associated vehicle part region.

2. The system of claim 1, wherein the object detection neural network comprises a You Only Look Once (YOLO) family model trained to identify at least scratches, dents, cracks, glass shatters, and lamp breakages as the specific damage categories.

3. The system of claim 1, wherein the segmentation neural network comprises a UNET model trained to identify specific exterior parts of the vehicle.

4. The system of claim 1, wherein the vision transformer neural network comprises a self-supervised DINO (Distillation with No Labels) model trained to generate feature vectors robust to variations in lighting, angle, and environmental conditions without requiring manual annotation of damage instances.

5. The system of claim 1, wherein updating the vector database comprises indexing each damage-specific feature vector using an indexing structure that enables efficient retrieval based on both the vehicle identifier and its associated vehicle part region.

6. The system of claim 1, wherein calculating similarity scores comprises computing a cosine similarity between each damage-specific feature vector of the plurality of damage instances and each of the previously stored feature vectors associated with corresponding vehicle part regions.

7. The system of claim 1, wherein performing local reidentification further comprises applying a Deep SORT (Simple Online and Realtime Tracking) algorithm to track damage instances across the multiple frames of the multi-angle video footage.

8. The system of claim 1, wherein the damage-specific feature vectors comprise high-dimensional embeddings that capture visual characteristics of the damage instances while being invariant to changes in camera perspective, lighting conditions, and environmental factors.

9. The system of claim 1, wherein the system is further configured to generate a damage report identifying the incremental damages, each incremental damage being associated with its associated vehicle part region.

10. The system of claim 1, wherein retrieving previously stored feature vectors comprises constraining the retrieval to only feature vectors associated with vehicle part regions corresponding to the plurality of damage instances, thereby reducing computational complexity and false positive matches.

11. A computer-implemented method for identifying incremental vehicle damages, comprising:
receiving a multi-angle video footage of a vehicle having a vehicle identifier;
identifying a plurality of damage instances in the multi-angle video footage using an object detection neural network trained to recognize specific damage categories;
determining, for each of the plurality of damage instances, a vehicle part region associated with the damage instance using a segmentation neural network;
generating, for each of the plurality of damage instances, a damage-specific feature vector using a vision transformer neural network;
performing local reidentification by:
tracking the plurality of damage instances across multiple frames of the multi-angle video footage based on feature vector similarity;
assigning unique identifiers to distinct damage instances among the plurality of damage instances;
performing global incremental damage detection by:
retrieving, from a vector database, previously stored feature vectors associated with the vehicle identifier and associated with vehicle part regions corresponding to the vehicle part regions determined for the plurality of damage instances;
calculating similarity scores between the damage-specific feature vectors of the plurality of damage instances and the previously stored feature vectors using a cosine similarity metric;
categorizing, as incremental damages, damage instances from the plurality of damage instances having similarity scores below a predetermined threshold; and
updating the vector database by storing the damage-specific feature vectors of the incremental damages, wherein each damage-specific feature vector is indexed in the vector database by both the vehicle identifier and its associated vehicle part region.

12. The computer-implemented method of claim 11, further comprising applying a Deep SORT (Simple Online and Realtime Tracking) algorithm to track damage instances across the multiple frames of the multi-angle video footage.

13. The computer-implemented method of claim 11, further comprising generating a damage report identifying the incremental damages, each incremental damage being associated with its associated vehicle part region.

14. The computer-implemented method of claim 11, wherein retrieving previously stored feature vectors comprises constraining the retrieval to only feature vectors associated with vehicle part regions corresponding to the plurality of damage instances, thereby reducing computational complexity and false positive matches.

15. The computer-implemented method of claim 11, wherein calculating similarity scores comprises computing a cosine similarity between each damage-specific feature vector of the plurality of damage instances and each of the previously stored feature vectors associated with corresponding vehicle part regions.
